(19) United States
(12) Patent Application Publication
(10) Pub. No.: US 2024/0386322 A1
(43) Pub. Date: Nov. 21, 2024

(54) MACHINE LEARNING MODEL INSTRUMENTATION HOOKS

(71) Applicant: OctoML, Inc., Seattle, WA (US)

(72) Inventors: Jason Knight, San Diego, CA (US); Luis Ceze, Seattle, WA (US); Itay Neeman, Seattle, WA (US); Jared Roesch, Seattle, WA (US); Andrew Reusch, Seattle, WA (US)

(21) Appl. No.: 18/647,339

(22) Filed: Apr. 26, 2024

Related U.S. Application Data
(60) Provisional application No. 63/503,325, filed on May 19, 2023.

(51) Int. Cl. G06N 20/00

(52) U.S. Cl. CPC G06N 20/00

(57) ABSTRACT

A facility for inserting instrumentation hooks into machine learning models is described. The facility receives an indication of a machine learning model and identifies one or more aspects of the machine leaning model. The facility receives an indication that an instrumentation hook is to be used to collect data for at least one aspect of the one or more aspects. The facility alters the machine learning model by inserting at least one instrumentation hook into the machine learning model and collects data regarding one or more aspects of the machine learning model via the instrumentation hook.

### BACKGROUND

Machine learning models are increasingly used to perform inferences for use in data analytics, software applications, etc.

### BRIEF DESCRIPTION OF THE SEVERAL VIEWS OF THE DRAWINGS

FIG. 1 is a block diagram showing some of the components typically incorporated in at least some of the computer systems and other devices on which the facility operates.

FIG. 2 is a flow diagram of a process to generate a machine learning model that includes instrumentation hooks performed by the facility in some embodiments.

FIG. 3 is a flow diagram of a process for inserting instrumentation hooks into a machine learning model by altering software code of a machine learning model performed by the facility in some embodiments.

FIG. 4 is a block diagram of a machine learning model with instrumentation hooks generated by the facility in some embodiments.

FIG. 5 is a table diagram of an example instrumentation hook data table used by the facility in some embodiments.

FIG. 6 is a flow diagram of a process to collect data from an instrumentation hook performed by the facility in various embodiments.

FIG. 7 is a flow diagram of a process to inject code via an instrumentation hook performed by the facility in some embodiments.

FIG. 8 is a table diagram of an example collected data table used by the facility in some embodiments.

FIG. 9 is a flow diagram of a process to apply optimizations to a machine learning model performed by the facility in some embodiments.

### DETAILED DESCRIPTION

Engineers who deploy models for use in certain tasks may attempt to obtain information regarding the performance of components of the machine learning models, such as tensors, weights, and other components of a machine learning model. This information is then used to provide insight into where a model can be improved, which issues are occurring with the performance of a model, why issues are occurring with the performance of a model, or other insights into the operation of a model.

The inventors have recognized that it would be of great benefit to developers, data scientists, etc., to be able to adapt their machine learning models to include instrumentation hooks that can be inserted into a machine learning model. The inventors have also determined that it would be beneficial to automate the process of determining where instrumentation hooks should be inserted into a machine learning model.

Developers, data scientists, and other users of machine learning models (collectively “users”) benefit from insight into the inner workings of those machine learning models. Such insight allows users to determine whether and where improvements to the machine learning model can be made, to observe how the machine learning model is built, to observe the contents of the model while it is generating inferences, to obtain diagnostic data from a model while it is generating inferences, and other observations or determinations regarding the performance of operation of a machine learning model. Conventionally, users manually determine where access points into the machine learning model will be inserted, and the model has to be manually adjusted to allow the access points to be added.

The inventors have recognized a variety of disadvantages with conventional practices to obtaining data regarding the performance or operation of the components of a machine learning model. First, conventional methods of obtaining this data require users to identify components in a machine learning model into which to insert access points before a machine learning model is built. Such methods require users to guess which components need access points to obtain data regarding the components. Thus, users are not able to use conventional methods to obtain all of the data that they need in order to improve the model.

Second, conventional methods of obtaining this data require users to adjust machine learning models after they are generated. Adjustment of a machine learning model may require reconfiguring the components of the model after the machine learning model is already generating inferences. Thus, the current workload of the machine learning model must be moved to another machine learning model in order to obtain the data regarding the model components. This results in a large amount of overhead to obtain the data regarding the model components.

In response to recognizing these disadvantages, the inventors have conceived and reduced to practice a software and/or hardware facility for obtaining data related to the inner workings of a machine learning model. By inserting instrumentation hooks into the machine learning model, the facility is able to retrieve data regarding the inner workings of a machine learning model without interrupting, or otherwise affecting, the operations of the machine learning model. The facility additionally automatically determines the optimal aspects of the machine learning model for insertion of the instrumentation hooks.

In the present application, references to “optimizing,” “optimization,” “optimize,” “optimal,” etc. means improving or seeking to improve the efficiency of aspects of a machine learning model. As a result, optimization can occur even if the facility fails to identify a more efficient implementation of the machine learning model or of aspects of the machine learning model, or the most efficient possible implementation of the machine learning model or aspects of the machine learning model.

The instrumentation hooks inserted into a machine learning model by the facility generate statistics, logs, or other data regarding aspects or components of the machine learning model. A component or aspect of the machine learning model includes: a tensor, a model layer, a node, or other aspects or components of a machine learning model. The facility automatically identifies aspects of the machine learning model for which instrumentation hooks should be inserted. In some embodiments, the facility differentiates aspects of the machine learning model based on the computer or software code that make up the aspects of the machine learning model and uses the differentiation of the aspects to determine where instrumentation hooks are to be inserted into the machine learning model. For example, a first set of tensors included in the machine learning model may use different software code than a second set of tensors included in the machine learning model. In such an example, the facility may differentiate the first and second sets of tensors, and may determine where instrumentation hooks should be inserted based on the differentiation of the tensors. In some embodiments, the facility uses conditions to configure the inserted instrumentation hooks.

In various embodiments, the facility identifies one or more aspects of the machine learning model for which instrumentation hooks should be inserted based on one or more of: user input, default aspects of a machine learning model determined based on the machine learning model, aspects of a machine learning model determined based on machine learning model optimization data, and other methods of identifying an aspect of a machine learning model for which instrumentation hooks should be inserted. In some embodiments, the facility receives user input regarding aspects of the machine learning model for which instrumentation hooks should be inserted. In some embodiments, the facility determines aspects of the machine learning model for which the operation of the machine learning model is not affected due to the insertion of an instrumentation hooks based on an indication of the machine learning model.

In some embodiments, the facility receives optimization data generated for one or more of: machine learning models similar to the machine learning model, such as machine learning models of a similar type to the machine learning model, machine learning models that are optimized for operation on hardware that the machine learning model will operate on, etc.; the machine learning model, such as optimization data obtained as a result of optimizing the machine learning model; or other sources of optimization data. For example, the facility may determine, based on the optimization data, that one or more operators used by the machine learning model result in high memory usage, such as memory usage that exceeds a selected threshold. In such an example, the facility inserts one or more instrumentation hooks into the machine learning model based on the determined aspects in order to obtain data regarding those aspects, such as data used to monitory the memory usage of the machine learning model.

The facility generates computer or software code for the instrumentation hooks when the facility optimizes, generates, trains, or otherwise creates or alters the machine learning model. In some embodiments, the generated code causes data regarding the operation of one or more aspects of the machine learning model to be output to one or more logs. In some embodiments, the code is generated to be inserted into the aspect of the machine learning model. For example, the facility may identify that an aspect of the machine learning model includes a loop that is executed as part of executing the aspect of the machine learning model. The facility configures the code for the instrumentation hook to be included in the loop, rather than in its own loop, in order to reduce the memory usage caused by using multiple loops. In some embodiments, the facility injects the code into the machine learning model via the instrumentation hooks while the machine learning model is operating.

The instrumentation hooks generated by the facility may be conditional hooks, unconditional hooks, or a combination thereof. A conditional instrumentation hook obtains data regarding one or more aspects of the machine learning model in response to a condition occurring. For example, the conditional instrumentation hook may be configured such that the contents of two tensors are aggregated, and to output data regarding one or more aspects of the machine learning model when the aggregated contents exceed a selected threshold. An unconditional instrumentation hook obtains data regarding one or more aspects of a machine learning model unconditionally. For example, the unconditional instrumentation hook may be configured such that the contents of one or more tensors are logged periodically.

The facility receives data output by the instrumentation hooks, such as by accessing logs or statistical data generated, populated, etc., by the instrumentation hooks. In some embodiments, the facility generates a user interface that presents at least a portion of the data output by the instrumentation hooks to a user. In some embodiments, the facility uses the data output by the instrumentation hooks to debug, re-train, or otherwise improve the machine learning model. For example, intermediate values of a machine learning model, such as values generated by a machine learning model as part of generating an inference, may be used to re-train, re-configure, or otherwise optimize the machine learning model to generate inferences more quickly.

By performing in some or all of the ways described above, the facility is able to efficiently obtain data regarding the inner workings of a machine learning model in order to optimize the machine learning model. The facility is also able to use the obtained data to optimize a machine learning model, by using the data to identify specific aspects of the machine learning model that can be improved.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by inserting instrumentation hooks into a machine learning model while it is being generated, and by automatically determining aspects of the machine learning model for which instrumentation hooks should be inserted, the facility is able to reduce the computing resources necessary to obtain data regarding the inner workings of a machine learning model. As an example, the facility is able to reduce the processing power and memory resources needed to obtain data regarding the inner workings of the machine learning model by reducing the number of reconfigurations of model components while it is already generating inferences. Furthermore, by using the instrumentation hooks to inject code into the machine learning model, the facility ensures that the regular operation of the machine learning model is not hindered by the collection of data and ensures that other computing resources do not have to be used in order to take on workload that the machine learning model is no longer able to process due to the data collection. Thus, the facility is able to reduce the computing resource overhead that conventional methods of obtaining data about the inner workings of a machine learning model require.

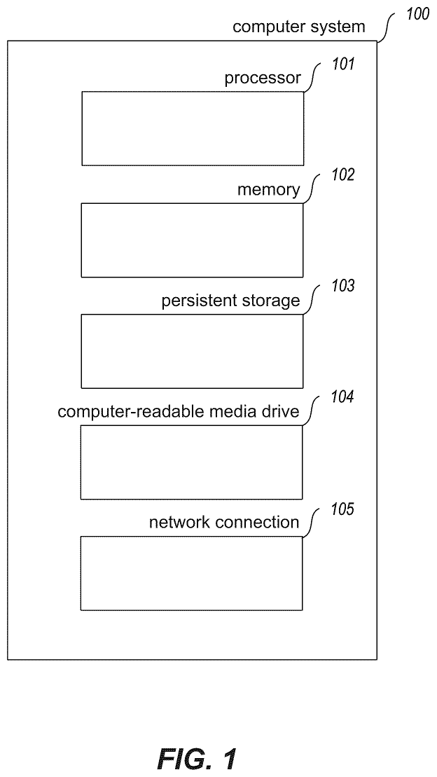

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, Neural Network Accelerator, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

Those skilled in the art will appreciate that the acts shown in the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

Furthermore, while the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

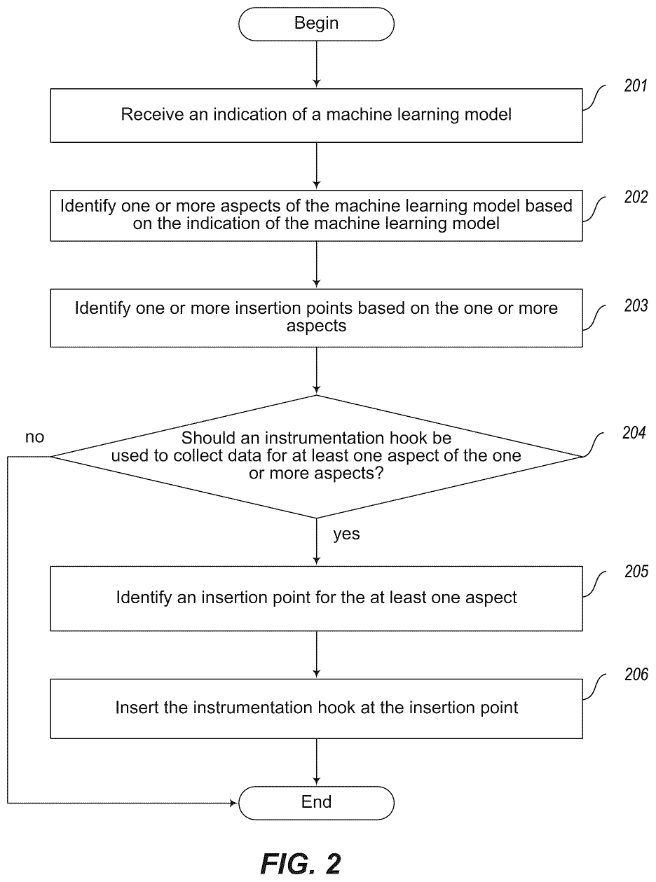

FIG. 2 is a flow diagram of a process to generate a machine learning model that includes instrumentation hooks performed by the facility in some embodiments. In some embodiments, the facility performs the process to alter a machine learning model to include instrumentation hooks as part of the initial generation or compilation of a machine learning model. First at act 401, the facility receives an indication of a machine learning model. In some embodiments, the machine learning model is an untrained machine learning model. In some embodiments, the indication of the machine learning model includes a description of the machine learning model in a machine learning exchange format such as CoreML, ONNX, etc.

At act 202, the facility identifies one or more aspects of the machine learning model for which data is to be collected based on the indication of the machine learning model. In some embodiments, the facility identifies the aspects of the machine learning model based on a definition of the machine learning model, an indication of a type of data to be collected, or some combination thereof. In such embodiments, the facility receives the indication of the type of data to be collected based on user input.

At act 203, the facility identifies one or more insertion points at which instrumentation hooks can be inserted based on the one or more aspects. In some embodiments, the facility identifies the one or more insertion points based on an implementation of each of the one or more aspects, an indication of the type of data to be collected, an indication of the hardware target for the machine learning model, or some combination thereof.

At act 204, the facility determines whether an instrumentation hook should be used to collect data for at least one aspect of the one or more aspects. If the facility determines that no instrumentation hooks should be used to collect data for the at least one aspect, the process ends, otherwise the process proceeds to act 205. In some embodiments, the facility determines whether an instrumentation hook should be used to collect data for at least one aspect of the one or more aspects based on one or more of: user input; an indication of a type of data to be collected; a list of pre-selected aspects of the machine learning model; one or more statistics or metrics associated with the machine learning model, such as, statistics related to the execution of one or more aspects of similar machine learning models, statistics related to the execution of one or more aspects of the instant machine learning model, statistics related the accuracy of the machine learning model, statistics related to the execution of one or more aspects of the machine learning model on or more hardware targets, or any other metrics or statistics related to the execution of a machine learning model; data used to optimize, or received as a result of optimizing, a machine learning model; or any other data that may be used to determine whether an instrumentation hook should be used to collect data related to an aspect of a machine learning model.

For example, the facility may receive statistics related to the runtime of certain tensors in a layer of the machine learning model and determine that one of the tensors is not performing well in relation to the other tensors. The facility may then determine that an instrumentation hook should be inserted into the tensor that is not performing well to collect data related to the execution of the tensor. The facility may also determine that an instrumentation hook should be inserted into other tensors to collect additional data needed to diagnose any issues with the tensor that is not performing well.

In another example, the facility may determine that an instrumentation hook should be inserted into an aspect of the machine learning model based on a pre-selected list of aspects that should include instrumentation hooks. In this example, the aspects included in the pre-selected list are selected based on one or more attributes of the machine learning model, one or more attributes of the aspects of the machine learning model, a hardware target of the machine learning model, the performance of other machine learning models with similar attributes, etc. For example, the facility may recognize that a tensor in the machine learning model has a certain implementation that is specified in the list as an aspect for which an instrumentation hook should be inserted. The facility may then determine that an instrumentation hook should be inserted into the tensor. As another example, the facility may identify an operator used in a tensor is one that typically has high memory usage, and may determine that the instrumentation hook should be inserted near the operator to monitory the memory usage.

At act 205, the facility identifies an insertion point for the at least one aspect based on the insertion points identified at act 203. In some embodiments, the facility identifies the insertion point based on an indication of the data to be collected, the identified insertion points, the software code of the aspect of the machine learning model, or some combination thereof. In some embodiments, the facility identifies an insertion point based on a projected impact of the instrumentation hook on the operation of the machine learning model.

For example, the facility may determine that the impact of the instrumentation hook would be lowered if the software code for the instrumentation hook was fused into a “hot loop” of code, such as by inserting the instrumentation hook inside a loop that already has to be implemented for the aspect of the machine learning model. By inserting the instrumentation hook into the loop, instead of inserting the hook outside of the loop, the facility is able to allow both the instrumentation hook and the machine learning model to perform their operations with a single read of memory instead of multiple reads.

At act 206, the facility inserts the instrumentation hook at the insertion point. For example, the facility may insert the code to implement the instrumentation hook into the code that implements the aspect of the machine learning model at the insertion point during generation or compilation of the machine learning model. By inserting the instrumentation hook during the compilation of the machine learning model, the facility is able to ensure that the instrumentation hook has as little impact on the performance of the model as possible, such as by allowing the instrumentation hook and the aspect of the machine learning model to obtain data via a single read of memory, implementing the instrumentation hook such that the hook is incorporated into the software code of the aspect of the machine learning model to optimize the amount of processing power needed to implement the instrumentation hook, or other methods of reducing the impact of an instrumentation hook on the machine learning model. For example, a condition of an instrumentation hook may be inserted into the software code that implements the aspect of the machine learning model in such a way that additional memory does not need to be expended to obtain the data necessary to evaluate the condition, and in such a way that evaluation of the condition uses as little extra processing power as possible.

In some embodiments, as part of performing act 206 for an instrumentation hook that injects software code, the facility inserts a listening port at the insertion point and instructions for where the injected code should be inserted during execution of the machine learning model. In some embodiments, the instructions for where the injected code should be inserted includes a symbol name or memory address.

In some embodiments, as part of performing act 206, the facility ensures that the instrumentation hook has read-only access to memory used by the machine learning model.

In some embodiments, as part of performing act 206, the facility ensures that use of the instrumentation hook does not use more than a threshold amount of memory or processing resources allocated for the machine learning model. In such embodiments, the facility may define a threshold amount of memory or processing resources and disable the instrumentation hook when the memory or processing resources used by the machine learning model exceed the threshold amount. In such embodiments, the facility may re-enable the instrumentation hook when the resources used by the machine learning model no longer exceed the threshold amount.

After act 206, the process ends.

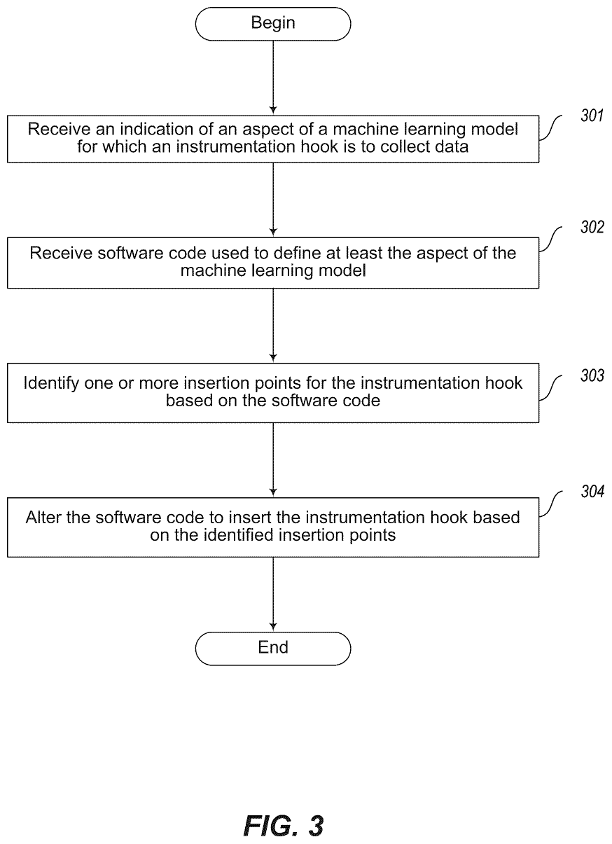

FIG. 3 is a flow diagram of a process for inserting instrumentation hooks into a machine learning model by altering software code of a machine learning model performed by the facility in some embodiments. First, at act 301, the facility receives an indication of an aspect of a machine learning model for which an instrumentation hook is to collect data. In some embodiments, the indicated aspect of the machine learning model is identified a similar manner to act 204.

At act 302, the facility receives software code used to define at least the aspect of the machine learning model. In some embodiments, the facility receives the software code based on data obtained from the compilation of the machine learning model.

At act 303, the facility identifies one or more insertion points for the instrumentation hook based on the software code. In some embodiments, the facility performs act 303 in a similar manner to act 205.

At act 304, the facility alters the software code to insert the instrumentation hook based on the identified insertion points. In some embodiments, the facility performs act 504 in a similar manner to act 206.

After act 304, the process ends.

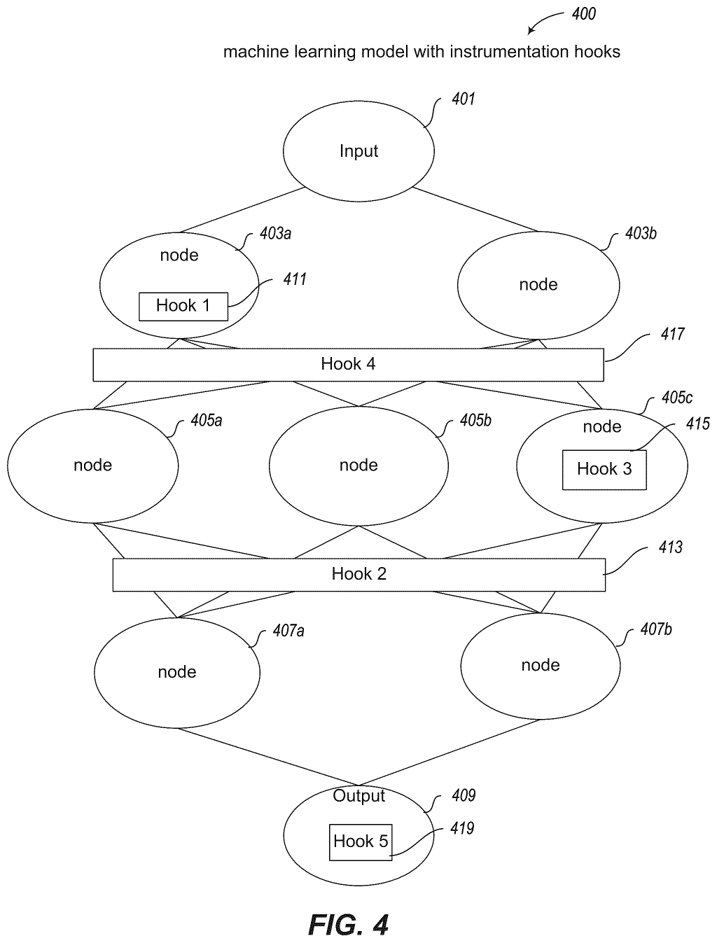

FIG. 4 is a block diagram of a machine learning model with instrumentation hooks 400 generated by the facility in some embodiments. The machine learning model includes an input block 401, an output block 409, first layer nodes 403a and 403b (“first layer nodes 403”), second layer nodes 405a, 405b, and 405c (“second layer nodes 405”), third layer nodes 407a and 407b (third layer nodes “407”), and instrumentation hooks 411, 413, 415, 417, and 419. In some embodiments, the facility alters software code for an existing machine learning model to include instrumentation hooks to generate the machine learning model with instrumentation hooks 400. In some embodiments, the facility inserts instrumentation hooks into a machine learning model as part of generating the machine learning model. Although the machine learning model with instrumentation hooks 400 includes instrumentation hooks in specific nodes and layers, embodiments are not so limited, and any aspect of the machine learning model with instrumentation hooks 400 may include one or more instrumentation hooks.

Each node block is made up of software code representing one or more operators, tensors, or other components of a node of a machine learning model; receives data from one or more parent nodes; processes the data according to the operators, tensors, and other components of the node; and feeds data to one or more child nodes. The input block 401 represents the part of the machine learning model that receives data used by the machine learning model. The output block 409 represents the part of the machine learning model that outputs an inference or any other output of a machine learning model. The output block includes an instrumentation hook 419, that is configured to collect data or take actions based on the output of the machine learning model.

The first layer nodes 403 represent the nodes included in a first layer of the machine learning model. Likewise, the second layer nodes 405, and the third layer nodes 407 represent nodes included in the second and third layers respectively. A node includes one or more tensors, and may additionally include an instrumentation hook, as indicated by the instrumentation hook 411 depicted as being included in the node 403a and instrumentation hook 415 depicted as being included in the node 405c. Furthermore, an instrumentation hook may be included in a tensor included in the node. Instrumentation hook 413 is depicted in between the second layer nodes 405 and third layer nodes 407, and is an instrumentation hook included in the third layer of the machine learning model. Likewise, instrumentation hook 417 is depicted in between the first layer nodes 403 and second layer nodes 405, and is an instrumentation hook included in the second layer of the machine learning model.

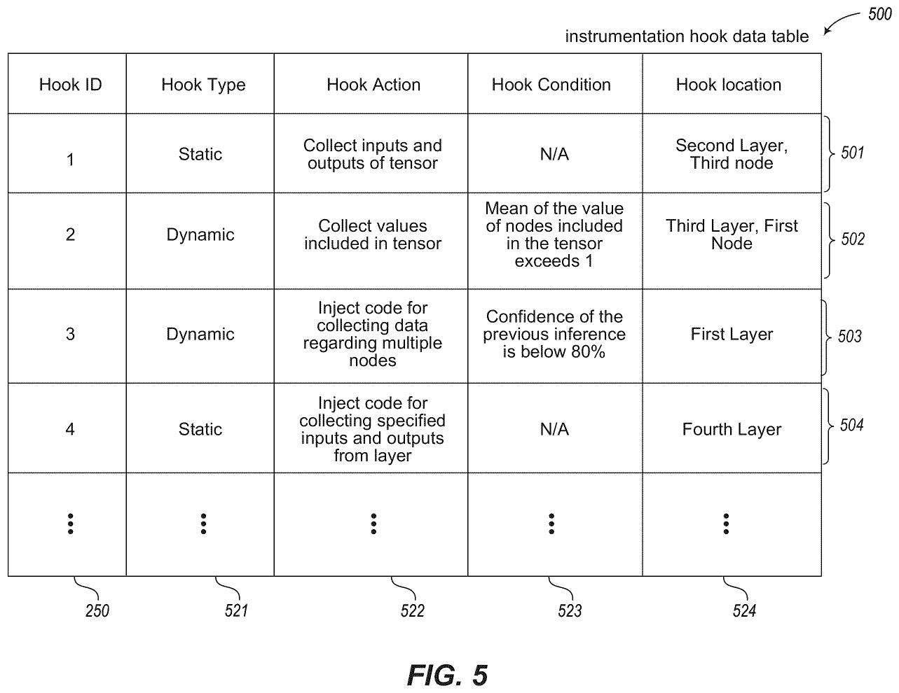

FIG. 5 is a table diagram of an example instrumentation hook data table 500 used by the facility in some embodiments. The instrumentation hook data table 500 includes data related to resource hooks included in a machine learning model. In some embodiments, the facility generates or updates the instrumentation hook data table 500 when instrumentation hooks are added or removed from a machine learning model. The facility uses the instrumentation hook data table 500 to store and access data related to instrumentation hooks included in a machine learning model. The rows of the instrumentation hook data table 500 each correspond to a different instrumentation hook included in the machine learning model. The instrumentation hook data table 500 includes a hook identifier column 520, a hook type column 521, a hook action column 522, a hook condition column 523, and a hook location column 524.

The hook identifier column 520 includes data indicating an identifier for a hook included in the machine learning model. The hook type column 521 includes data indicating a type of the instrumentation hook identified by the hook identifier column 520. In some embodiments, instrumentation hook types may include “static” and “dynamic.” A static hook is a hook that unconditionally executes during the execution of the machine learning model. A dynamic hook is a hook that executes during the execution of the machine learning model if a condition has been met.

The hook action column 522 includes data indicating an action taken by, or via, an instrumentation hook identified in the hook identifier column 520. In some embodiments, instrumentation hook is configured to cause, take, or be used for, a variety of actions, including collecting one or more values related to one or more aspects of the machine learning model, manipulating or altering one or more values related to one or more aspects of the machine learning model, aggregating one or more values related to one or more aspects of the machine learning model, injecting code into a machine learning model, determining whether a condition has been met, or other actions that may be taken by, or via, an instrumentation hook.

The hook condition column 523 includes data indicating a condition for the use of an instrumentation hook identified in the hook type identifier column 520. In some embodiments, the conditions relate to a value generated by one or more aspects of a machine learning model as a part of executing the code related to one or more aspects of the machine learning model, an input to one or more aspects of the machine learning model, an output of one or more aspects of the machine learning models or other values, inputs, outputs, or other data used or generated via the execution of the machine learning model. In some embodiments, conditions are based on comparisons of one or more values to one or more other values, a determination that one or more values exceed or are within a threshold range of values, or other types of conditions.

The hook location column 524 includes data indicating a location within a machine learning model of an instrumentation hook identified in the hook identifier column 500. An instrumentation hook may be incorporated into a machine learning model layer, node, tensor, slice of a tensor, or other aspects of a machine learning model.

For example, row 501 indicates that a static instrumentation hook is used to collect inputs and outputs of a tensor located in the second layer and third node of the machine learning model. Likewise, row 504 indicates that a static instrumentation hook located in the third layer of the machine learning model is used to inject code for collecting specified inputs and outputs from the layer. Row 502 indicates that a dynamic instrumentation hook located in the first node of the third layer of the machine learning model is used to collect values included in a tensor on the condition that the mean of the value of the nodes included in the tensor exceeds one. Row 503 indicates that a dynamic instrumentation hook located in the first layer of the machine learning model is used to inject code for collecting data related to multiple nodes on the condition that the confidence of the previous inference is below eighty percent.

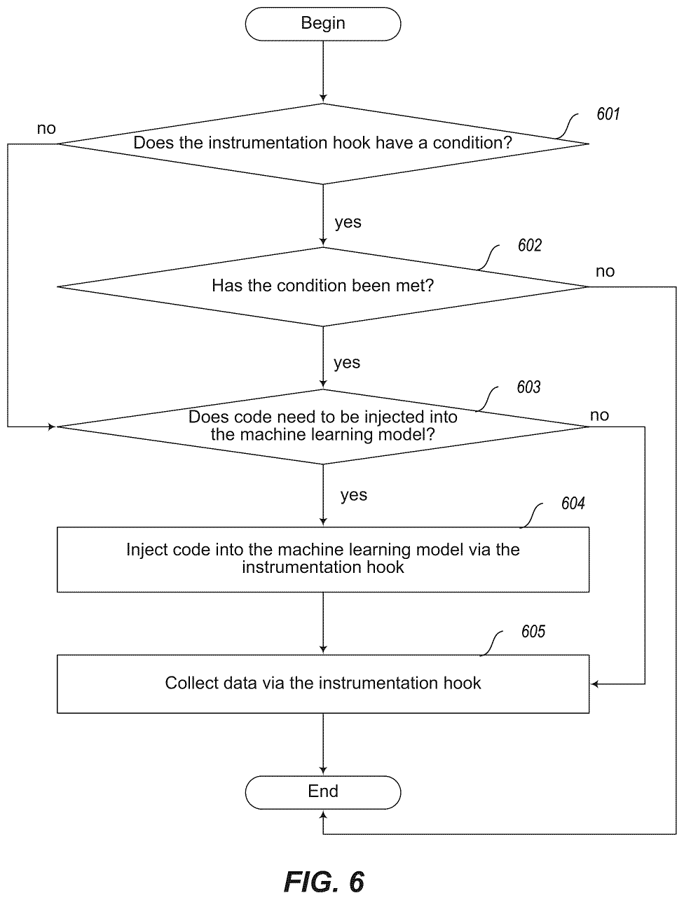

FIG. 6 is a flow diagram of a process to collect data from an instrumentation hook used by the facility in various embodiments. The process to collect data form an instrumentation hook may be performed during execution of the machine learning model. First, at act 601, the facility determines whether an instrumentation hook has a condition. If the instrumentation hook has a condition, the process proceeds to act 602, otherwise, the process proceeds to act 603.

At act 602, the facility determines whether the condition has been met. If the condition has been met, the process proceeds to act 603, otherwise, the process ends. In some embodiments, the facility determines whether the condition has been met by evaluating the condition via the instrumentation hook. In some embodiments, the facility determines whether the condition has been met by determining whether a flag indicating that the condition has been met is detected by the facility. In such embodiments, the machine learning model, an application running the machine learning model, or another instrumentation hook, may set a flag that a certain condition has been met, and the facility may determine if the condition has been met based on the flag. In some embodiments, the condition includes one or more or: a model statistic, such as a percentile, average, sum, or other aggregation, exceeds a certain threshold; a computation obtained by combining values included in multiple aspects of the machine learning model; a comparison of values included in multiple aspects of the machine learning model; an input or output of the machine learning model; an input to or output of the machine learning model; a range of statistics related to the operation of the machine learning model; intermediate values of aspects of the machine learning model; or other data regarding the execution of the machine learning model. For example, an instrumentation hook may be used to collect data on the condition that the difference of values of two tensors is greater than a certain threshold. In this example, when the difference of the values of the two tensors exceeds the threshold, a flag will be set such that the instrumentation hook is able to determine whether the condition has been met.

At act 603, the facility determines whether code is to be injected into the machine learning model via the instrumentation hook. In some embodiments, the facility determines whether code is to be injected into the machine learning model based on one or more attributes of the instrumentation hook, data describing the instrumentation hook, or some combination thereof. If code is to be injected into the machine learning model via the instrumentation hook, the process proceeds to act 604, otherwise, the process proceeds to act 605.

At act 604, the facility injects code into the machine learning model via the instrumentation hook. In some embodiments, the code injected into the machine learning model is code specified by the user. In some embodiments, the code injected into the machine learning model is code generated by the facility based on one or more of a type of data that is to be collected, the insertion point for the instrumentation hook, the aspect of the machine learning model associated with the instrumentation hook, or other data used to generate code that is injected into a machine learning model via an instrumentation hook. In some embodiments, the facility performs act 604 by using a process to inject code via an instrumentation hook.

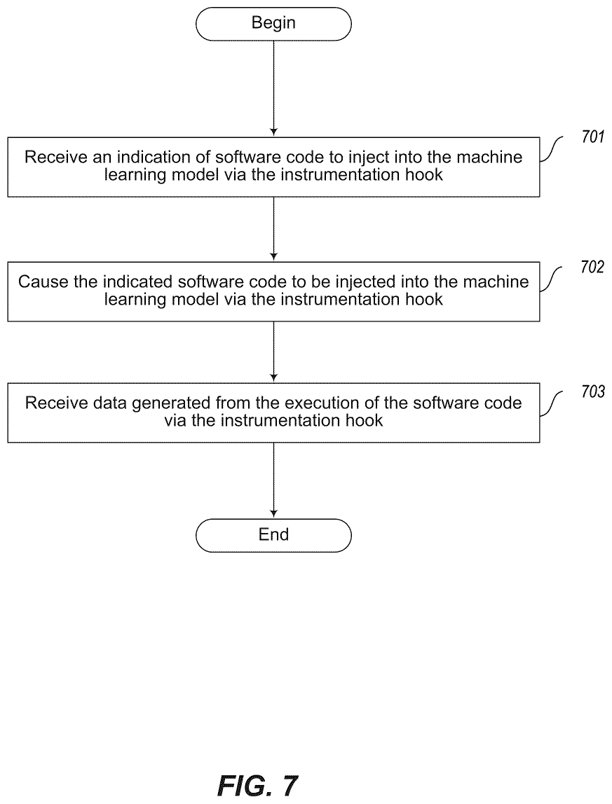

FIG. 7 is a flow diagram of a process to inject code via an instrumentation hook performed by the facility in some embodiments. First, at act 701, the facility receives an indication of software code to inject into the machine learning model via the instrumentation hook. In some embodiments, the software code includes one or more of: code that includes a condition, code that manipulates data before it is processed by an aspect of the machine learning model, code that overrides other software code included in the machine learning model, code that manipulates data after it is processed by an aspect of the machine learning model, code that collects data from one or more aspects of the machine learning model, code that combines or otherwise aggregates data from one or more aspects of the machine learning model, or other software code.

At act 702, the facility causes the software code to be injected into the machine learning model via the instrumentation hook. By injecting the software code into the machine learning model, the facility causes the software code to be executed within the context of the execution of the machine learning model at the insertion point of the instrumentation hook. For example, software code injected by using an instrumentation hook that is inside of a loop will execute as if the software code is included inside of the loop.

At act 703, the facility receives data generated from the execution of the software code via the instrumentation hook.

After act 703, the process ends.

Returning to FIG. 6, at act 605, the facility collects data via the instrumentation hook. In some embodiments, the collected data includes one or more of: a summary of one or more aspects of the machine learning model; an input, output, or intermediate value of the machine learning model; an execution time of the aspect of the machine learning model; an aggregate of one or more values of the machine learning model; or other data related to the aspect of the machine learning model. In some embodiments, the collected data is aggregated with data received from other instrumentation hooks, other data received from the instrumentation hook, data received from sources external to the machine learning model, or some combination thereof. In such embodiments, the collected data may be used to generate one or more graphs, histograms, dashboards, reports, or some combination thereof that represent the state of at least one aspect of the machine learning model. In such embodiments, the generated graphs, histograms, dashboards, reports, etc. may be measured across time, model dimensions, or some combination thereof.

After act 605, the process ends.

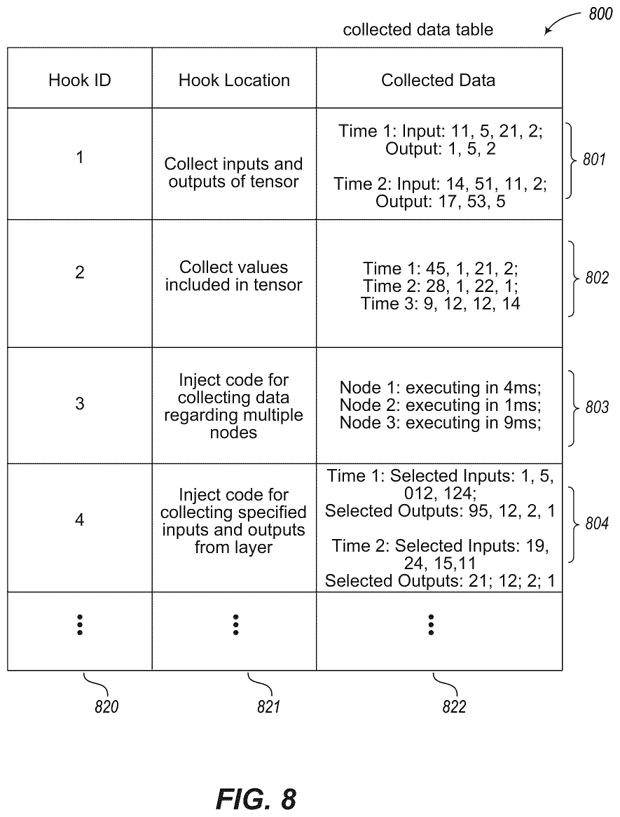

FIG. 8 is a table diagram of an example collected data table 800 used by the facility in some embodiments. The collected data table 800 includes data collected by instrumentation hooks included in a machine learning model. In some embodiments, the facility updates the collected data table 800 as data is collected from instrumentation hooks included in the machine learning model. The facility uses the collected data table 800 to store and access data collected via instrumentation hooks. The rows of the collected data table 800 each correspond to a different instrumentation hook included in the machine learning model. The collected data table 800 includes a hook identifier column 820, a hook location column 821, and a collected data column 822.

The hook identifier column 820 is similar to the hook identifier column 520, described above in connection with FIG. 5. The hook location column 821 is similar to the hook location column 521, described above in connection with FIG. 5. The collected data column 822 includes data indicating data collected by or via the instrumentation hook indicated by the hook id column 821. Data collected by or via the instrumentation hooks may include one or more of: performance data for one or more aspects of the machine learning model, such as latency, throughput, probability distributions, or other performance data; histogram data, such as data collected over time from one or more aspects of the machine learning model; execution time data; memory utilization data; memory statistics; data included in an aspect of the machine learning model; an aggregation of data included in one or more aspects of the machine learning model, such as a mean, median, mode, summation, or other aggregations of data; input or output data for one or more aspects of the machine learning model; or other data that may be collected from an aspect of a machine learning model.

For example, row 801 indicates that a hook has been used to collect inputs and outputs of a specific tensor at two different times. Row 802 indicates that a hook has been used to collect internal values of a tensor at three different times. Row 803 indicates that a hook has been used to inject code into the machine learning model that collects data regarding the execution times for multiple nodes. Row 804 indicates that a hook has been used to inject code into the machine learning model to obtain specific inputs and outputs from a layer.

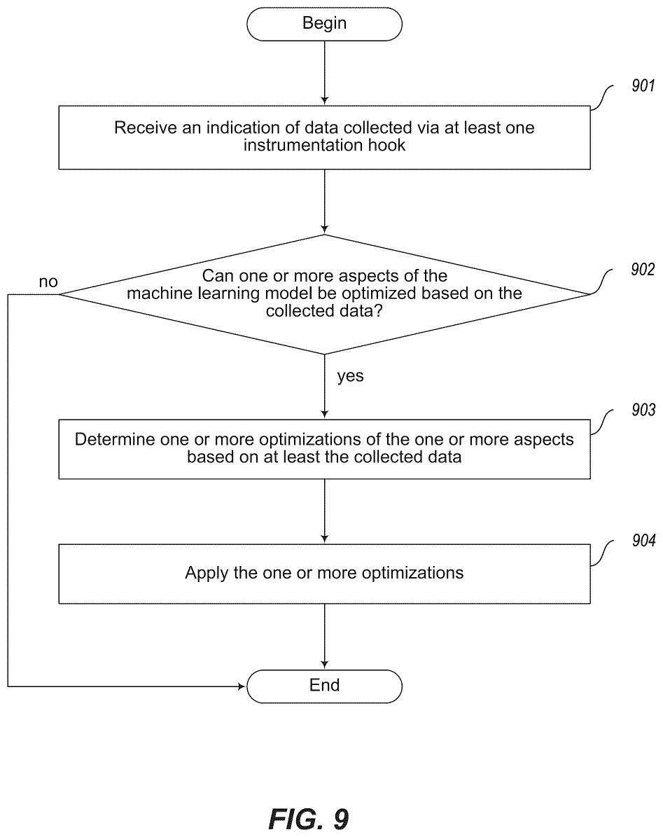

FIG. 9 is a flow diagram of a process to apply optimizations to a machine learning model performed by the facility in some embodiments. At act 901, the facility receives an indication of data that has been collected via at least one instrumentation hook. In some embodiments, the data is collected via the process described above in connection with FIG. 6.

At act 902, the facility determines whether one or more aspects of the machine learning model can be optimized based on the collected data. If one or more aspects of the machine learning model can be optimized based on the collected data, the process proceeds to act 903, otherwise, the process ends. In some embodiments, the facility determines whether one or more aspects of the machine learning model can be optimized based on the collected data and optimization result data generated as a result of optimizing one or more machine learning models similar to the machine learning model. For example, a similar machine learning model may be identified based on a hardware target of the machine learning models, similar configurations of the machine learning model, or other attributes of the machine learning models.

At act 903, the facility determines one or more optimizations of the one or more aspects of the machine learning model based on at least the collected data. In some embodiments, the one or more optimizations include one or more of: changing the structure of the machine learning model, changing the software code used to implement the machine learning model, changing one or more tensors included in the machine learning model, changing the way data is preprocessed before being input into the machine learning model, or other optimizations of a machine learning model. In some embodiments, the facility determines the one or more optimizations of the one or more aspects of the machine learning model based on the collected data and optimization result data obtained from optimizing other machine learning models.

At act 904, the facility applies the one or more optimizations to the machine learning model.

After act 904, the process ends.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for inserting instrumentation hooks into a machine learning model, the system comprising:
a computing device configured to:
receive an indication of a machine learning model;
identify one or more aspects of the machine learning model, wherein the one or more aspects of the machine learning model include one or more of:
a tensor;
a layer; or
a node;
receive an indication that an instrumentation hook is to be used to collect data for at least one aspect of the one or more aspects of the machine learning model; and
based on the received indication, alter the machine learning model by inserting at least one instrumentation hook into the machine learning model, the instrumentation hook being configured to collect data regarding the at least one aspect.

2. The system of claim 1, wherein the instrumentation hook includes a condition and wherein the instrumentation hook is configured to:
collect data regarding the at least one aspect based on a determination that the condition has been met.

3. The system of claim 1, wherein the instrumentation hook is configured to:
collect data regarding the at least one aspect while the machine learning model is generating an inference.

4. The system of claim 1, wherein the instrumentation hook is configured to:
receive software code related to the collection of data regarding the at least one aspect; and
cause the software code to be executed.

5. The system of claim 1, wherein the computing device is further configured to:
generate one or more graphs based on at least the data collected via the at least one instrumentation hook.

6. The system of claim 1, wherein the computing device is further configured to:
identify an aspect of the one or more aspects of the machine learning model to optimize based on at least the data collected via the at least one instrumentation hook.

7. The system of claim 6, wherein the computing device is further configured to:
cause the identified aspect to be optimized based on at least the data collected via the at least one instrumentation hook.

8. The system of claim 1, wherein to insert at least one instrumentation hook into the machine learning model, the computing device is further configured to:
identify at least one insertion point based on the at least one aspect;
determine the extent to which the insertion of the at least one instrumentation hook at the at least one insertion point will impact the operation of the machine learning model; and
based on the determination, insert the at least one instrumentation hook within the machine learning model at one or more insertion points of the at least one insertion point.

9. The system of claim 1, wherein the indication that an instrumentation hook is to be used to collect data for at least one aspect of the one or more aspects of the machine learning model is based on one or more of:
user input identifying second one or more aspects of the machine learning model;
aspects of the machine learning model selected based on the indication of the machine learning model; or
one or more performance-based heuristics associated with each aspect of the one or more aspects of the machine learning model.

10. A method comprising:
receiving an indication of a machine learning model;
identifying one or more aspects of the machine learning model;
receiving an indication that an instrumentation hook is to be used to collect data for at least one aspect of the one or more aspects of the machine learning model, the indication that the instrumentation hook is to be used being based on one or more of:
user input identifying second one or more aspects of the machine learning model;
aspects of the machine learning model selected based on the indication of the machine learning model; or
one or more performance-based heuristics associated with each aspect of the one or more aspects of the machine learning model;
based on the received indication, inserting at least one instrumentation hook into the machine learning model; and
collecting data via the instrumentation hook.

11. The method of claim 10, wherein collecting data via the at least one instrumentation hook further comprises:
determining whether a condition associated with the instrumentation hook has been met; and
based on the determining, collecting the data regarding the at least one aspect via the at least one instrumentation hook.

12. The method of claim 10, further comprising:
generating one or more graphs based on at least the data collected via the at least one instrumentation hook.

13. The method of claim 10, further comprising:
identifying an aspect of the one or more aspects of the machine learning model to optimize based on at least the data collected via the at least one instrumentation hook.

14. The method of claim 13, further comprising:
causing the identified aspect to be optimized based on at least the data collected via the at least one instrumentation hook.

15. The method of claim 10, wherein inserting the at least one instrumentation hook further comprises:
identifying at least one insertion point based on the at least one aspect;
determining the extent to which the insertion of the at least one instrumentation hook at the at least one insertion point will impact the operation of the machine learning model; and
based on the determination, inserting the at least one instrumentation hook within the machine learning model at one or more insertion points of the at least one insertion point.

16. One or more instances of computer-readable media collectively having contents configured to cause a computing device to perform a method for inserting instrumentation hooks into a machine learning model, the method comprising:
receiving an indication of a machine learning model;
identifying one or more aspects of the machine learning model, wherein the one or more aspects of the machine learning model include one or more of:
a tensor;
a layer; or
a node;
receiving an indication that an instrumentation hook is to be used to collect data for at least one aspect of the one or more aspects of the machine learning model;
based on the received indication, inserting at least one instrumentation hook into the machine learning model; and
collecting data via the instrumentation hook.

17. The one or more instances of computer-readable media of claim 16, wherein collecting data via the at least one instrumentation hook further comprises:
determining whether a condition associated with the instrumentation hook has been met; and
based on the determining, collecting the data regarding the at least one aspect via the at least one instrumentation hook.

18. The one or more instances of computer-readable media of claim 16, wherein the method further comprises:
generating one or more graphs based on at least the data collected via the at least one instrumentation hook.

19. The one or more instances of computer-readable media of claim 16, wherein the method further comprises:
identifying an aspect of the one or more aspects of the machine learning model to optimize based on at least the data collected via the at least one instrumentation hook.

20. The one or more instances of computer-readable media of claim 18, wherein the method further comprises:
causing the identified aspect to be optimized based on at least the data collected via the at least one instrumentation hook.

21. The one or more instances of computer-readable media of claim 16, wherein inserting the at least one instrumentation hook further comprises:
identifying at least one insertion point based on the at least one aspect;
determining the extent to which the insertion of the at least one instrumentation hook at the at least one insertion point will impact the operation of the machine learning model; and
based on the determination, inserting the at least one instrumentation hook within the machine learning model at one or more insertion points of the at least one insertion point.
